(19) United States
(12) Patent Application Publication
(10) Pub. No.: US 2013/0052345 A1
(43) Pub. Date: Feb. 28, 2013

(54) POROUS ELASTOMERIC INFILLS

(71) Applicant: Frank BOWERS, Javea (ES)

(72) Inventor: Frank BOWERS, Javea (ES)

(21) Appl. No.: 13/218,243

(22) Filed: Aug. 25, 2011

(51) Int. Cl. B05D 5/00; B05D 7/24; B05D 3/00; C08L 75/00

(52) U.S. Cl. 427/243; 521/137

(57) ABSTRACT

A method of forming a porous elastomeric composition and an infill for installation at the base of trees and signs comprising the steps of encapsulating recycled rubber—styrene butadiene rubber (SBR)—with pigmented polyurethane to form cured SBR granules, mixing the coloured SBR granules with a polyurethane based moisture curing prepolymer to form an uncured porous polymeric composition, applying the uncured porous polymeric composition to the base of a tree or sign, tamping the uncured porous polymeric composition until its uppermost surface is level with a surrounding area and allowing the porous polymeric composition to set.

This invention relates to porous elastomeric infills and particularly, although not exclusively, to such infills for use at the base of trees and sign posts in rural, urban and other areas.

In urban locations, trees planted in paved areas in paved areas may incorporate an area at the base of the tree that is free of paviors, i.e. a tree-well, to facilitate the transmission of water to the tree roots. The tree-well is often fitted with a cast iron grid that prevents the sub-soil from being compacted due to foot traffic, since compacted sub-soil would prevent the transmission of water.

Such cast iron grids have serious disadvantages. They are extremely expensive. Unsightly waste material accumulates between the grid elements and is extremely difficult to remove. The base of the tree usually expands with time due to normal growth and causes the grid elements to slit and rise above their intended level.

If a tree-well is not protected from foot traffic, the sub-soil compacts, thus reducing the water and nutrient supply to the tree roots. This ultimately results in the tree becoming distressed and possibly eventually dying.

In soft landscaped grassy areas, the grass and weeds at the bases of trees have to be cut using a mechanical grass/weed cutting machine—strimming This is a labour intensive and costly activity.

A solution to prevent soil compaction and facilitate vital watering of the tree roots is to install either a pre-formed or a wet-poured porous polymeric tree well infill or ring.

The compositions of known such porous decorative elastomeric infills comprise of coloured synthetic rubber, such as ethylene-propylene-diene-momomer-rubber (EPDM) or vulcanized thermoplastic (TPV) for example, adhered together by polyurethane-based moisture curing pre-polymer (‘binder’). However, EPDM, TPV and binder are very expensive, and moreover the bulk density of EPDM and TPV is considerably greater than that of recycled rubber. This means that such compositions are expensive and not environmentally friendly since considerable energy is required to manufacture nascent EPDM and TPV. See, for example, U.S. Pat. No. 7,452,159.

Preformed polymeric composition tree-rings have predetermined apertures. Such tree-rings therefore do not locate precisely to the tree trunk and are liable to damage due to contact with the mower blade during grass cutting.

The present invention seeks to overcome the above disadvantages by providing improved methods and materials for the production of cost-effective, environmentally friendly, decorative porous elastomeric infills for installation at the base of trees and signs.

According to one aspect of the present invention there is provided a method of forming a porous elastomeric infill for installation at the base of trees and signs, comprising the steps of encapsulating particles of recycled rubber—styrene butadiene rubber (SBR)—with pigmented polyurethane to form coloured SBR granules, mixing the coloured SBR granules with a polyurethane based moisture curing prepolymer to form an uncured porous polymeric composition, applying the uncured porous polymeric composition to the base of a tree or sign, and allowing the porous composition to set.

In an aspect of the invention, the polymeric composition and/or the prepolymer may be in liquid form.

The method may include the additional step of excavating an area at the base of the tree or sign prior to the application of the uncured porous polymeric composition.

An embodiment of the invention will now be described by way of example only.

Pigmented polyurethane is formed by mixing to homogeneity 18% by weight of iron oxide pigment and 82% by weight of MDI polyurethane based prepolymer with a free NCO of 8.5%. 10% by weight of the pigmented polyurethane is mixed with 90% by weight of SBR granules having a size range of 2 mm to 6 mm. The uncured mixture of pigmented polyurethane and SBR particles is kept agitated until the pigmented polyurethane is cured—to prevent agglomeration of the particles—to form coloured SBR granules.

The coloured SBR granules are then mixed with 8% by weight of moisture curing prepolymer to form an uncured coloured porous polymeric composition, the composition then being applied to a prepared area at the base of a tree or sign and allowed to set. The composition may also be coated with a catalytically active medium to accelerate curing.

The resultant porous polymeric infill so formed will withstand foot traffic and will not compact, thus allowing the transmission water/rain and nutrients to the roots of a tree.

There are no voids or areas that will allow the accumulation of waste material and the infill is easily cleaned by brushing

Strimming around the tree or sign in grassed areas is eliminated.

The porous decorative elastomeric composition used to form the infill is considerably cheaper than conventional cast iron grids and the composition—infill will expand with any growth of the tree.

The porous decorative elastomeric composition so formed is of the order of 50% cheaper than if it were formed with EPDM/TPV because:

coloured SBR granules described herein are approximately 50% cheaper than coloured EPDM/TPV granules;

the coverage rate of coloured SBR is approximately 40% greater than that of EPDM/TPV due to the difference in density of EPDM/TPV c.f. coloured SBR;

the binder requirement to facilitate a composite strong enough to withstand foot traffic of the elastomeric polymeric composition described herein is approximately 50% less than if it comprised of coloured EPDM/TPV because there is 10% by weight of polyurethane on the surface of the coloured SBR granules and the tensile strength of tyre rubber is 500% greater than EPDM/TPV.

The incorporation of recycled scrap tyres and the use of less polyurethane is much more environmentally friendly than alternative systems.

It will be appreciated that the invention is not limited to the example given herein. Many variations, such as might readily occur to one skilled in the art, are possible, without departing from the spirit and scope of the invention.

Finally, it will be understood that there is no restriction with respect to the size of the SBR granules.

1. A method of forming a porous elastomeric composition for use as an infill for installation at the base of trees and signs comprising encapsulating recycled rubber—styrene butadiene rubber (SBR)—with pigmented polyurethane to form coloured SBR granules, and mixing the coloured-SBR granules with a polyurethane based moisture curing prepolymer to form an uncured porous polymeric composition.

2. A method of forming a porous elastomeric infill for installation at the base of trees and signs comprising encapsulating recycled rubber—styrene butadiene rubber (SBR)—with pigmented polyurethane to form coloured SBR granules, mixing the coloured SBR granules with a polyurethane based moisture curing prepolymer to form an uncured porous polymeric composition, applying the uncured porous polymeric composition to the base of a tree or sign, tamping the uncured porous polymeric composition until its uppermost surface is level with a surrounding area and allowing the composition to set.

3. A method according to claim 2, including the further step of excavating an area at the base of the tree or sign prior to the application of the uncured porous polymeric composition.

4. A method according to claim 2, wherein the polymeric composition is or includes a liquid polymer.

5. A method according to claim 4, wherein the liquid polymer is polyurethane-based or epoxy-based or any other suitable liquid polymer.

6. A method according to claim 2, wherein the particle size of the rubber granules is 1 mm to 50 mm or any mixture thereof

7. A method according to claim 3, wherein the particle size of the rubber granules is 1 mm to 50 mm or any mixture thereof

8. A method according to claim 4, wherein the particle size of the rubber granules is 1 mm to 50 mm or any mixture thereof

9. A method according to claim 5, wherein the particle size of the rubber granules is 1 mm to 50 mm or any mixture thereof

10. A method according to claim 2, wherein the pigmented polyurethane incorporates a UV stabilizer.

11. A method according to claim 3, wherein the pigmented polyurethane incorporates a UV stabilizer.

12. A method according to claim 4, wherein the pigmented polyurethane incorporates a UV stabilizer.

13. A method according to claim 5, wherein the pigmented polyurethane incorporates a UV stabilizer.

14. A method according to claim 6, wherein the pigmented polyurethane incorporates a UV stabilizer.

15. A method according to claim 2, wherein, after tamping of the composition, it is coated with a catalytically active medium to accelerate curing.

16. A method according to claim 2, wherein the porous elastomeric infill is applied to an existing tree well or sign in a paved area.

17. A method according to claim 2, wherein the porous elastomeric infill is applied to excavated areas around the base of trees or signs in a grassed area.

18. A method according to claim 2, wherein the porous elastomeric infill is applied between the members of an existing metal tree well grid.
